(19) United States
(12) Patent Application Publication
(10) Pub. No.: US 2003/0231820 A1
(43) Pub. Date: Dec. 18, 2003

(54) Optical switch

(76) Inventors: Norio Chiba, Chiba-shi (JP); Yasuyuki Mitsuoka, Chiba-shi (JP); Hidetaka Maeda, Chiba-shi (JP); Susumu Ichihara, Chiba-shi (JP); Kenji Kato, Chiba-shi (JP); Takashi Niwa, Chiba-shi (JP); Yoko Shinohara, Chiba-shi (JP); Norihiro Dejima, Chiba-shi (JP)

Correspondence Address: ADAMS & WILKS, 31st Floor, 50 Broadway, New York, NY, 10004, US

(21) Appl. No.: 10/422,399

(22) Filed: Apr. 24, 2003

(30) Foreign Application Priority Data
Apr. 25, 2002 (JP) 2002-124258

(51) Int. Cl. G02B 6/26

(52) U.S. Cl. 385/16

(57) ABSTRACT

An optical switch of high performance excellent in insertion loss, the reproducibility of return loss and the temperature property and easily mechanically driven is provided by forming the end faces of optical fibers to be small, the optical fibers are mounted in the optical switch used for switching and cutting off optical transmission lines in optical fiber communications. In the optical switch in the invention, the optical fiber is configured in which the outer diameter of an end part continued to a transmission part for transmitting light is smaller than the outer diameter of the transmission part and greater than the diameter of a core.

### BACKGROUND OF THE INVENTION

1. Field of the Invention

The present invention relates to an optical switch used in optical-communications for switching and cutting off optical paths such as optical fiber transmission lines.

2. Description of the Related Art

Traditionally, for an optical switch for switching and cutting off the optical paths of optical fiber transmission lines used in optical communications field, many mechanical optical switches having the structure in which optical fibers and prisms are directly driven to switch the optical paths have been used.

The mechanical optical switch having the structure in which the optical fibers are directly driven to switch and cut off the optical paths has a relatively simple structure, and has the characteristics to obtain low insertion loss, a small-sized product, and low power consumption. Therefore, many structures have been proposed so far. One example is disclosed in JP-A-63-313111. FIG. 8 depicts the structure.

This structure is a 1×2 optical switch type, which is configured of a movable bare optical fiber 1 having the base part fixed to a first cylindrical tube 7 like a cantilever and having a magnetic body 5 with a desired magnetic property fixed to the surface near the tip end, a hollow solenoid 6 for inverting the magnetic poles of the magnetic body 5 by changing the direction of current carried through, a pair of permanent magnets 8a and 8b for applying magnetic attractive force to the magnetic body 5 in the direction orthogonal to the optical axis, two static bare optical fibers fixed to a V-shaped groove 4 formed in the flat part of half cylinders 3a and 3b (not shown in the drawing), and a long cylindrical sleeve 9 for aligning and holding the first cylindrical tube 7 and the half cylinders 3a and 3b and for fixing the hollow solenoid 6 and the permanent magnets 8a and 8b.

The operation of the structure is as shown below. Depending on the magnetic poles at the both end parts of the magnetic body 5, the movable bare optical fiber 1 is magnetically attracted to one of the pair of the permanent magnets 8a and 8b, and the tip end is optically coupled to one of the two static bare optical fibers in the V-shaped groove 4 formed in the flat part of the half cylinders 3a and 3b. Current is carried through the hollow solenoid 6 to apply a magnetic field to the magnetic body 5 along the optical axis, and then the magnetic poles at the both ends of the magnetic body 5 are inverted. Consequently, the movable bare optical fiber 1 is attracted to the other permanent magnet to be optically coupled to the other static bare optical fiber. Also in the state of not feeding current, the magnetic body 5 is magnetically attracted to the permanent magnet. Thus, the movable bare optical fiber 1 can hold in the coupled state to the one static bare optical fiber, and the self holding type of switching operation can be obtained.

The operation is related to a 1×2 optical switching operation. However, focusing attention on one of the optical paths, the optical path can be opened/closed and cut off, and thus the optical switch can be used as an optical shutter.

However, in the optical switch shown in FIG. 8, the end faces of the optical fibers are faced closely in parallel with each other. Therefore, there has been a problem that interference due to the multi-reflection of light in the end faces of the optical fibers causes the reproducibility of insertion loss and return loss and the temperature property to be reduced. Because of the same reason, also in an optical switch or an optical shutter in which a shield or mirror is taken in and out of the optical path, the end faces of the optical fibers are faced closely to each other, or the end faces of the optical fibers are faced closely to the optical shield or the mirror. Thus, there has been a problem that multi-reflection similarly causes the reproducibility of insertion loss and return loss and temperature property to be reduced.

In the case where the optical switch shown in FIG. 8 is used as the optical shutter, the movable optical fiber has needed to be traveled more than the distance equivalent to the diameter of the end face so as not to have the portion of the end face of the movable optical fiber faced to the end face of the fixed optical fiber in order to prevent crosstalk when the optical path is cut off. The outer diameter of the bare optical fiber generally used is 125 micrometers, and thus the travel distance of the end face requires at least 125 micrometers or greater.

Moreover, in the case of an optical switch in which the end faces of a plurality of optical fibers are closely arranged in a cross shape or T-shape, claddings of the optical fibers physically interfere with each other when the traditional optical fibers are used. Therefore, there has been a problem that the end faces of the optical fibers cannot be arranged closely to each other at the distance of the cladding diameter or below to increase the insertion loss. For example, the distance between the end faces is about 10 micrometers, the insertion loss is one decibel or below. However, it is several decibels at a distance of 125 micrometers equivalent to the outer diameter of the optical fiber.

In the meantime, as for the elasticity of the optical fiber, the optical switch for driving the optical fiber shown in FIG. 8 has had a problem that the drive mechanism for the optical fiber needs to generate a driving force equal to or greater than the elasticity of the optical fiber. For example, a spring constant of an optical fiber having an outer diameter of 125 micrometers in a length of three millimeters is about 100 N/m, but the spring constant is proportional to the fourth power of the outer diameter. Thus, when the outer diameter of the optical fiber is half, the spring constant is several N/m, the optical fiber can be driven by a driving force of an order or more of magnitude smaller.

### SUMMARY OF THE INVENTION

It is an object of the present invention to provide an optical switch of high performance excellent in the reproducibility of insertion loss and return loss and the temperature property and easily mechanically driven by forming the end face of the optical fiber to be small.

In order to achieve the object, an optical switch in the invention is characterized by including: a support; a movable optical fiber having a first end face at an end part in which a base part is fixed to the support at a predetermined distance from the end part to be movable like a cantilever; a fixed optical fiber having a second end face at an end part, the fixed optical fiber nearly collinearly arranged with the movable optical fiber in which the second end face is faced to the first end face in parallel with each other at a predetermined interval; and a drive mechanism for driving the movable optical fiber, the optical switch for driving the movable optical fiber like a cantilever to open/close an optical path, wherein the movable optical fiber and the fixed optical fiber are optical fibers formed of a core for propagating light and a cladding disposed around the core, the cladding having a refractive index smaller than a refractive index of the core, and an outer diameter of the end part continued to a transmission part for transmitting light is smaller than an outer diameter of the transmission part and greater than a diameter of the core.

Accordingly, the end faces of the optical fibers are formed to be small. Thus, the influence of interference due to the multi-reflection of light is reduced between the end faces of the optical fibers, the reproducibility of insertion loss and return loss and the temperature property can be improved, and the movable optical fiber is moved at a short travel distance to allow the influence of crosstalk to be small.

An optical switch in the invention is characterized by including: a support; a movable optical fiber having a first end face at an end part in which a base part is fixed to the support at a predetermined distance from an the end part to be movable like a cantilever; a first fixed optical fiber having a second end face at an the end part, the first fixed optical fiber arranged nearly collinearly or nearly in parallel with the movable optical fiber in which the second end face is faced to the first end face in parallel with each other at a predetermined interval in a first position of the movable optical fiber; a second fixed optical fiber having a third end face at an end part, the second fixed optical fiber arranged nearly in parallel with the first fixed optical fiber in which the third end face is faced to the first end face in parallel with each other at a predetermined interval in a second position of the movable optical fiber; and a drive mechanism for driving the movable optical fiber, the optical switch for driving the movable optical fiber like a cantilever to switch optical paths, wherein the movable optical fiber and the first and second fixed optical fibers are optical fibers formed of a core for propagating light and a cladding disposed around the core, the cladding having a refractive index smaller than a refractive index of the core, and an outer diameter of the end part continued to a transmission part for transmitting light is smaller than an outer diameter of the transmission part and greater than a diameter of the core.

Accordingly, the end faces of the optical fibers are formed to be small. Therefore, the influence of interference due to the multi-reflection of light is reduced between the end faces of the optical fibers, and the reproducibility of insertion loss and return loss and the temperature property can be improved.

An optical switch in the invention is characterized by including: a support; two optical fibers faced to each other over the support so that end faces are in parallel with each other, the two optical fibers arranged nearly collinearly at a predetermined interval; a light shield; and a drive mechanism for driving the light shield, the optical switch for taking the light shield in and out between the end faces of the two optical fibers to open/close optical paths, wherein the two optical fibers are optical fibers formed of a core for propagating light and a cladding disposed around the core, the cladding having a refractive index smaller than a refractive index of the core, and an outer diameter of the end part continued to a transmission part for transmitting light is smaller than an outer diameter of the transmission part and greater than a diameter of the core.

Accordingly, the end faces of the optical fibers are formed to be small. Thus, the influence of interference due to the multi-reflection of light is reduced between the end faces of the optical fibers and between the end faces of the optical fibers and the light shield, and the reproducibility of insertion loss and return loss and the temperature property can be improved.

An optical switch in the invention is characterized by including: a support; four optical fibers faced to each other over the support so that end faces of the optical fibers are in parallel with each other, the optical fibers arranged in an almost cross shape at a predetermined interval; a light reflector; and a drive mechanism for driving the light reflector, the optical switch for taking the light reflector in and out of a central space where the four optical fibers are arranged at a predetermined angle to switch optical paths, wherein the four optical fibers are optical fibers formed of a core for propagating light and a cladding disposed around the core, the cladding having a refractive index smaller than a refractive index of the core, and an outer diameter of the end part continued to a transmission part for transmitting light is smaller than an outer diameter of the transmission part and greater than a diameter of the core.

Accordingly, the end faces of the optical fibers are formed to be small. Therefore, the influence of interference due to the multi-reflection of light is reduced between the end faces of the optical fibers and between the end faces of the optical fibers and the light reflector, and the reproducibility of insertion loss and return loss and the temperature property can be improved. The interval between the end faces can be arranged closely, and thus the insertion loss can be reduced.

In the optical switch wherein one optical fiber is removed among the four optical fibers to switch the optical paths among the three optical fibers arranged in an almost T-shape, the optical switch is characterized in that: the three optical fibers are optical fibers formed of the core for propagating light and the cladding disposed around the core, the cladding having the refractive index smaller than the refractive index of the core, and the outer diameter of the end part continued to the transmission part for transmitting light is smaller than the outer diameter of the transmission part and greater than the diameter of the core.

Accordingly, the end faces of the optical fibers are formed to be small. Therefore, the influence of interference due to the multi-reflection of light is reduced between the end faces of the optical fibers and between the end faces of the optical fibers and the light reflector, and the reproducibility of insertion loss and return loss and the temperature property can be improved. The interval between the end faces can be arranged closely, and thus the insertion loss can be reduced.

The optical switch in the invention is characterized in that the optical fiber has an almost cone shape where an outer diameter is smaller as close to the end face near the end part.

Accordingly, an optical fiber having a small end face can be easily realized.

The optical switch in the invention is characterized in that the optical fiber has a tapered shape where an outer diameter is smaller as close to the end face near the end part, and has an almost cylindrical shape continued from the tapered shape.

Accordingly, an optical fiber having a small end face can be easily realized. In addition, the portion of the almost cylindrical shape continued from the tapered shape with the small outer diameter is elastically deformed, which allows an optical fiber to be easily mechanically driven effortlessly.

The optical switch in the invention is characterized in that the optical fiber has a wedge shape near the end part.

Accordingly, an optical fiber having a small end face can be easily realized.

The optical switch in the invention is characterized in that the end face of the optical fiber is flat, and is in parallel or at a predetermined angle to a plane orthogonal to the core.

Accordingly, the end part is formed flat, and thus the end parts can be brought closer to each other. Furthermore, the end part is formed to have a predetermined angle to the plane orthogonal to the core, which allows the return loss to be reduced.

The optical switch in the invention is characterized in that an anti-reflection coating is formed over the end part of the optical fiber.

Accordingly, the multi-reflection between the end faces can be reduced effectively, and the return loss can be further decreased.

### BRIEF DESCRIPTION OF THE DRAWINGS

FIG. 1 is a schematic diagram illustrating an optical fiber in embodiment 1 of the invention;

FIG. 2 is a schematic diagram illustrating an optical fiber in embodiment 2 of the invention;

FIGS. 3A and 3B are schematic diagrams illustrating an optical fiber in embodiment 3 of the invention;

FIGS. 4A and 4B are a top view (4A) and a side view (4B) illustrating an optical switch in embodiment 4 of the invention;

FIG. 5 is a schematic diagram illustrating an optical switch in embodiment 5 of the invention;

FIG. 6 is a schematic diagram illustrating an optical switch in embodiment 6 of the invention;

FIG. 7 is a schematic diagram illustrating an optical switch in embodiment 7 of the invention; and

FIG. 8 is a perspective view illustrating the exemplary structure of the traditional optical switch.

### DESCRIPTION OF THE PREFERRED EMBODIMENTS

Hereafter, embodiments of the invention will be described with reference to the drawings.

Embodiment 1

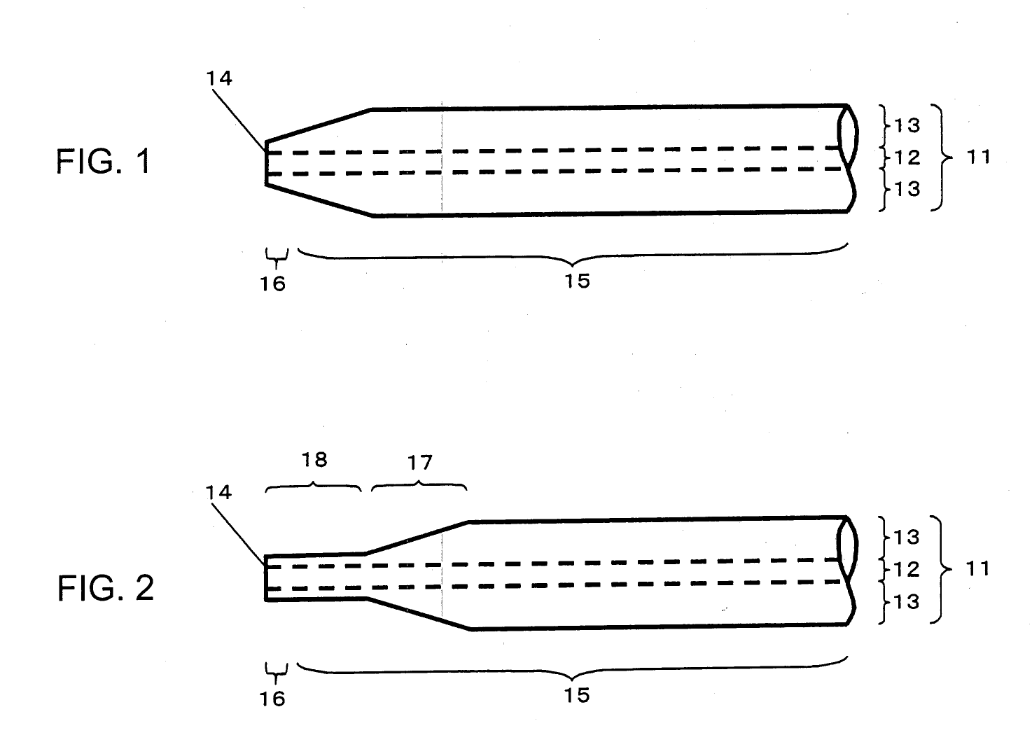

FIG. 1 is a diagram illustrating the configuration of an optical fiber in embodiment 1.

An optical fiber 11 is formed of a core 12 for propagating light and a cladding part 13 having a different refractive index. The vicinity of an end part 16 continued to a transmission part 15 for transmitting light is shaped into a cone shape where the outer diameter is gradually reduced toward an end face 14. The outer diameter of the end part 16 is formed smaller than the diameter of the optical fiber 11 and greater than the diameter of the core 12. The end face 14 is a plane in parallel with the plane orthogonal to the central axis direction of the core 12. For the optical fiber 11, single mode fibers, multimode fibers and polarization maintaining fibers having various core diameters and cladding diameters can be used.

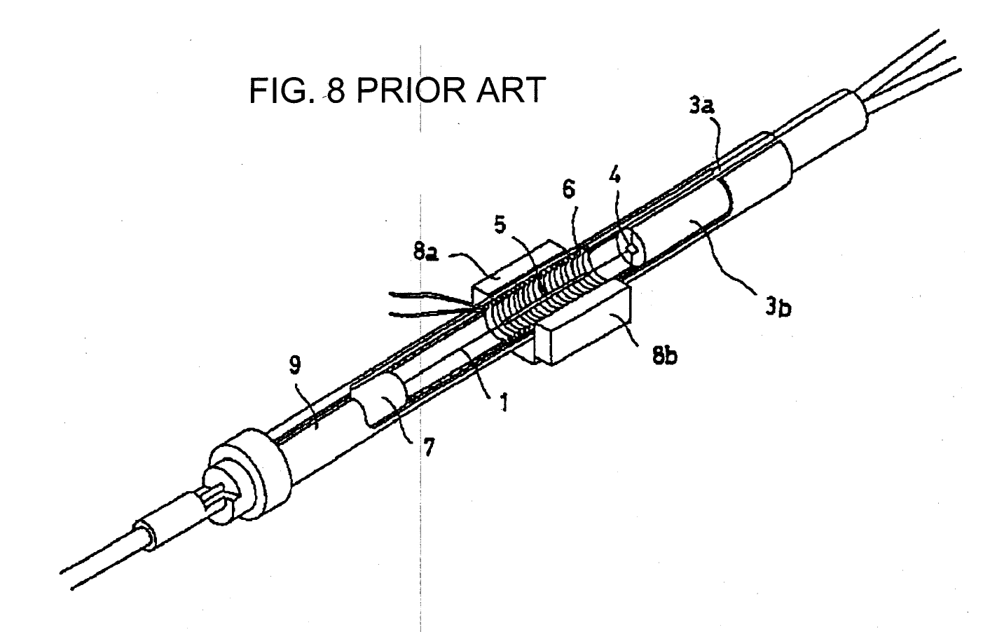

In the case of a single mode fiber for optical communications having a cladding diameter of about 125 micrometers and a core diameter of about 10 micrometers, for example, transmission loss is small even though the outer diameter of the end part 16 is reduced to about 20 micrometers. In this case, the area of the end face 14 is 1/30 of the end face of the traditional optical fiber or below. As shown in the traditional example in FIG. 8, in the optical switch, the end faces of the optical fibers are arranged closely in parallel. This case has had a problem that the reproducibility of insertion loss and return loss and the temperature property are reduced due to interference caused by the multi-reflection of light between the end faces of the optical fibers. As shown in the embodiment, the area of the end face of the optical fiber 14 is reduced to allow the influence of multi-reflection to be decreased. In addition, a refractive index matching oil is filled between the optical fibers faced to each other, and thus the influence of multi-reflection can be reduced. Furthermore, an anti-reflection coating is formed over the end face 14, which can reduce the influence of multi-reflection as well. When the anti-reflection coating is formed, the advantage to decrease the return loss can also be expected.

Moreover, in an optical switch in which one of two optical fibers faced to each other is driven to open/close optical signals, the travel of the optical fiber is only set nearly equal to the diameter of the end face 14, and then crosstalk can be reduced effectively. More specifically, when the diameter of the end face 14 is set to about 20 micrometers in a single mode fiber for optical communications having a cladding diameter of about 125 micrometers and a core diameter of about 10 micrometers as similar to the example, the travel of the optical fiber is enough to be about 20 micrometers.

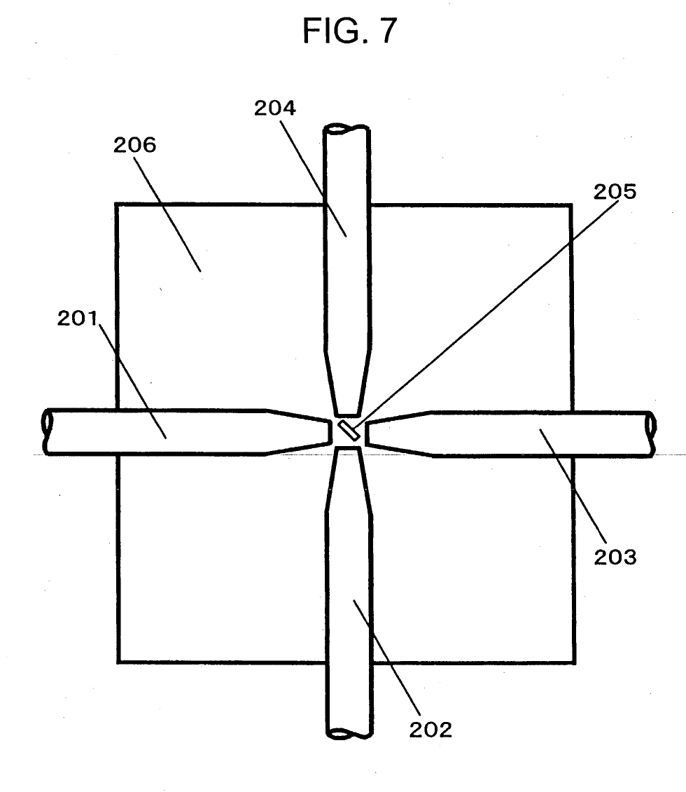

Besides, the detail will be described in embodiment 7 shown in FIG. 7, which will be described later, but the diameter of the end part 16 is reduced to allow the tip ends of the optical fibers to come closer to each other in an optical switch in which optical fibers are arranged in a cross shape or T-shape. Therefore, an optical switch with small insertion loss can be obtained.

The optical fiber in a form shown in FIG. 1 can be fabricated easily by applying the traditional polishing techniques. The chemical etching methods allow the optical fiber to be sharpened, and the optical fiber can also be fabricated by combining mechanical polishing. As an etchant for chemical etching, hydrofluoric acid mixed with ammonium fluoride as a buffer agent and a double layered etchant of hydrofluoric acid having a layer of an organic solvent or oil and fat thereon are used, hydrofluoric acid is not mixed with the organic solvent or oil and fat.

As described above, according to the optical switch having the optical fiber of the invention mounted, an optical switch of high performance can be realized in which the multi-reflection between the end faces of the optical fibers is prevented, and the reproducibility of insertion loss and return loss and the temperature property are improved. In addition, in the optical fiber driven optical switch, the influence of crosstalk can be reduced because of a short travel distance, and the interval between the end faces can be arranged closer to reduce the insertion loss, allowing an optical switch of high performance to be realized.

Furthermore, in FIG. 1, the end face 14 was formed to be the plane in parallel with the plane orthogonal to the core 12. However, the end face 14 is tilted from the plane orthogonal to the core 12 to allow the return loss to be reduced, in addition to the effect and advantage. A tilt angle of about four to eight degrees is adopted.

Embodiment 2

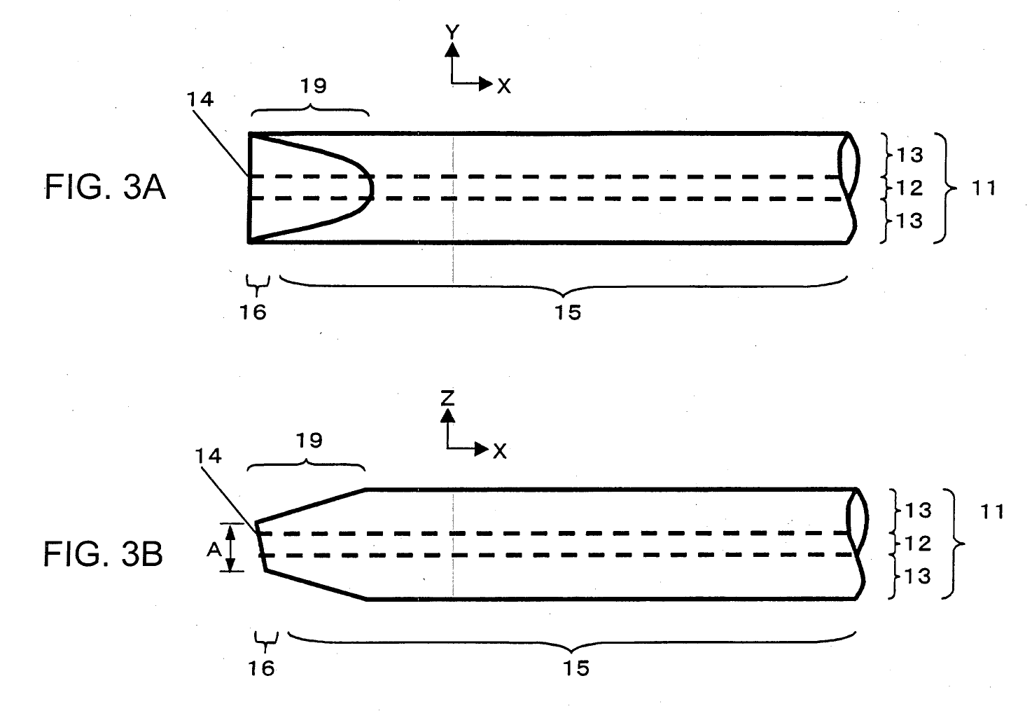

FIG. 2 is a diagram illustrating the configuration of an optical fiber in embodiment 2 of the invention.

An optical fiber 11 is formed of a core 12 for propagating light and a cladding part 13 having a different refractive index. Near an end part 16, a tapered part 17 where the outer diameter is gradually reduced toward an end face 14 and a cylindrical part 18 continued from the tapered part 17 are formed. The outer diameter of the cylindrical part 18 is formed smaller than the diameter of the optical fiber 11 and greater than the diameter of the core 12. The end face 14 is a plane in parallel with the plane orthogonal to the core 12. In addition, the end face 14 can also be tilted at angle of four to eight degrees to the plane orthogonal to the central axis direction of the core 12 as well. Furthermore, an anti-reflection coating can be formed over the end face 14 as well.

The embodiment 2 shown in FIG. 2 varies the shape near the end part 16 from the embodiment 1 described in FIG. 1, but the effect and advantage are the same.

In the case of the optical switch for driving the optical fiber, the cylindrical part 18 is formed in a predetermined length, which allows forming an optical fiber easily driven having a small spring constant. For example, a spring constant of a cantilever is about 100 N/m in the optical fiber having an outer diameter of 125 micrometers in a length of three millimeters. The spring constant is proportional to the fourth power of the outer diameter of the optical fiber. Therefore, when the outer diameter of the optical fiber is half, the spring constant is several N/m, an order or more of magnitude smaller. More specifically, the optical fiber can be driven at a driving force of an order of magnitude smaller. The cylindrical part 18 is formed into a portion to be elastically deformed, which allows realizing an optical fiber easily mechanically driven.

The form of the optical fiber shown in FIG. 2 can be fabricated by combining the chemical etching methods and mechanical polishing.

Embodiment 3

FIGS. 3A and 3B are diagrams illustrating the configuration of an optical fiber in embodiment 3 of the invention. FIG. 3A is a top view, and FIG. 3B is a side view. In the drawing, the X-, Y- and Z-coordinates are depicted.

An optical fiber 11 is formed of a core 12 for propagating light and a cladding part 13 having a different refractive index. Near an end part 16, a wedge part 19 is formed. As shown in FIG. 3B, height A of an end face 14 at the tip end of the wedge part is formed smaller than the diameter of the optical fiber 11 and greater than the diameter of the core 12. The end face 14 is tilted to the plane orthogonal to the central axis direction of the core 12. In this case, a tilt angle is selected from four to eight degrees, and the tilt direction is desirably the direction rotating about the Y-axis in the end face 14. The end face 14 can also be formed orthogonal to the central axis direction of the core 12. An anti-reflection coating can be disposed over the end face 14 as well.

The embodiment 3 shown in FIGS. 3A and 3B varies the shape near the end part 16 from the embodiment 1 described in FIG. 1, but the effect and advantage are the same. However, in the optical switch in which optical fibers are arranged in a cross shape or T-shape in the embodiment 7 shown in FIG. 7, the wedge part 19 needs to be arranged in the direction where the plane of the support is orthogonal to the Y-axis.

Embodiment 4

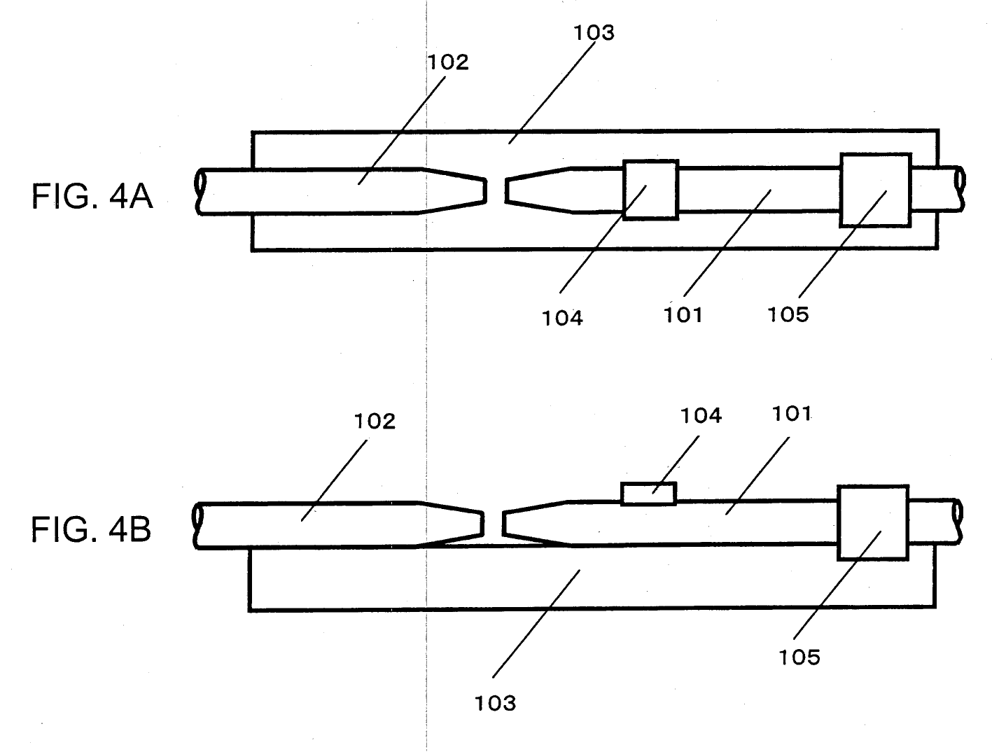

FIGS. 4A and 4B are schematic diagrams illustrating the configuration of an optical switch in embodiment 4 of the invention. FIG. 4A is a top view, and FIG. 4B is a side view.

A movable optical fiber 101 and a fixed optical fiber 102 are disposed over a support 103. In both cases where the end faces of the optical fibers are orthogonal to the central axis direction of the core, and where they are tiled to the plane orthogonal to the core, the end face of the movable optical fiber 101 and the end face of the fixed optical fiber 102 are arranged in parallel with each other at a predetermined interval, and the movable optical fiber 101 and the fixed optical fiber 102 are disposed nearly collinearly. The base part of the movable optical fiber 101 is fixed by a fixing mechanism 105 disposed at a predetermined distance from the end part, and the movable optical fiber 101 can bend like a cantilever in the upper direction in FIG. 4B. The movable optical fiber 101 is disposed with a drive mechanism 104, which is configured to bend the movable optical fiber 110. The fixed optical fiber 102 is tightly fixed to the support 103. For the movable optical fiber 101 and the fixed optical fiber 102, the optical fibers described in the embodiment 1 to the embodiment 3 of the invention are used. For the drive mechanism 104, various drive mechanisms can be used including an electromagnetic drive mechanism, an electrostatic drive mechanism, and a mechanical drive mechanism. For the fixing mechanism 105, a mechanical fixing mechanism and an adhesive are used. The configuration in which a guide groove such as a v-groove is formed in the support 103 to arrange the movable optical fiber 101 and the fixed optical fiber 102 in the guide groove is desirable in that the positioning accuracy is enhanced.

When the end face of the movable optical fiber 101 is faced to the end face of the fixed optical fiber 102, the optical path is formed to transmit optical signals each other. At this time, the optical fibers of the invention are disposed, and thus the influence of the multi-reflection of light between the end faces of the optical fibers can be reduced. Accordingly, the reproducibility of insertion loss and return loss and the temperature property can be improved, and the optical switch of high performance can be realized.

The drive mechanism 104 allows the movable optical fiber 101 to bend like a cantilever, and then the optical path is cut off. At this time, even though the cores of the optical fibers are not faced to each other, optical signals are reflected between the end faces, and enter the cores to generate crosstalk. In order to reduce crosstalk, it is fine that the end face of the movable optical fiber is moved at the distance where the end face of the movable optical fiber 101 is not fully faced to the end face of the fixed optical fiber 102, that is, the distance equivalent to the diameter of the end part. In the optical switch having the optical fibers of the invention mounted, the movable optical fiber is moved at a short travel distance to allow crosstalk to be reduced.

Embodiment 5

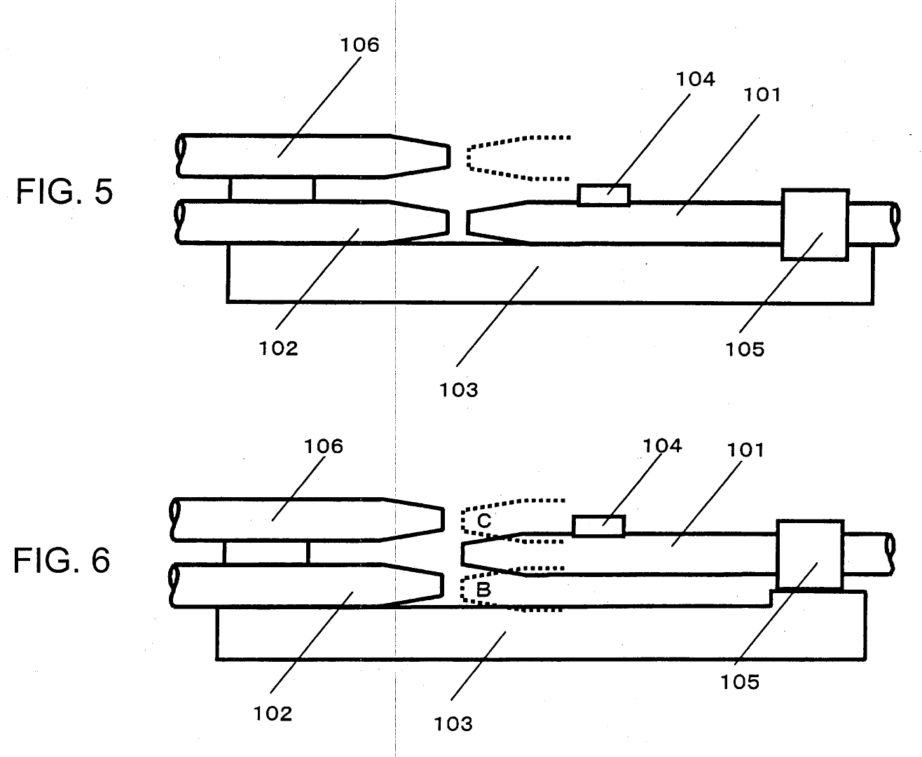

FIG. 5 is a schematic diagram illustrating an optical switch in the embodiment 5 of the invention.

A movable optical fiber 101, a first fixed optical fiber 102 and a second fixed optical fiber 106 are disposed over a support 103. The base part of the movable optical fiber 101 is fixed by a fixing mechanism 105 disposed at a predetermined distance from the end part, and the movable optical fiber 101 can bend like a cantilever in the upper direction in FIG. 5. The movable optical fiber 101 is disposed with a drive mechanism 104, which is configured to bend the movable optical fiber 101. The difference from the embodiment 4 shown in FIG. 4 is in that the end face of the movable optical fiber 101 and the end face of the second fixed optical fiber 102 are arranged in parallel with each other at a predetermined interval in a second position (depicted by a dotted line) of the movable optical fiber and the second fixed optical fiber 106 is arranged in parallel with the first fixed optical fiber 102. For the movable optical fiber 101, the first fixed optical fiber 102 and the second fixed optical fiber 106, the optical fibers described in the embodiment 1 to the embodiment 3 in the invention are used. According to the configuration of the optical switch shown in FIG. 5, it is apparent from the description in FIG. 4 and the embodiment 4 that a lx 2 optical switch can be configured easily.

According to the configuration of the optical switch described above, the influence of the multi-reflection of light between the end faces of the optical fibers can be reduced. Accordingly, the reproducibility of insertion loss and return loss and the temperature property can be improved, and the optical switch of high performance can be realized.

Embodiment 6

FIG. 6 is a schematic diagram illustrating the configuration of an optical switch in embodiment 6 of the invention.

A movable optical fiber 101, a first fixed optical fiber 102 and a second fixed optical fiber 106 are disposed over a support 103. The base part of the movable optical fiber 101 is fixed by a fixing mechanism 105 disposed at a predetermined distance from the end part, and the movable optical fiber 101 can bend like a cantilever in the vertical direction shown in FIG. 6. The movable optical fiber 101 is disposed with a drive mechanism 104, which is configured to bend the movable optical fiber 101. The difference from the embodiment 5 shown in FIG. 5 is in that the end face of the movable optical fiber 101 and the end face of the first fixed optical fiber 102 are arranged in parallel with each other at a predetermined interval in a first position (depicted by dotted line B) of the movable optical fiber and the end face of the movable optical fiber 101 and the end face of the second fixed optical fiber 106 are arranged in parallel with each other at a predetermined interval in a second position (depicted by dotted line C) of the movable optical fiber. More specifically, in the state that the drive mechanism 104 is not operated, the optical path is cut off. The movable optical fiber 101, the first fixed optical fiber 102 and the second fixed optical fiber 106 are arranged in parallel with each other. For the movable optical fiber 101, the first fixed optical fiber 102 and the second fixed optical fiber 106, the optical fibers described in the embodiment 1 to the embodiment 3 in the invention are used. According to the configuration of the optical switch shown in FIG. 6, it is apparent from the description in FIG. 5 and the embodiment 5 that a 1×2 optical switch can be configured easily.

According to the configuration of the optical switch described above, the influence of the multi-reflection of light between the end faces of the optical fibers can be reduced. Accordingly, the reproducibility of insertion loss and return loss and the temperature property are improved, and the optical switch of high performance can be realized.

Embodiment 7

FIG. 7 is a schematic diagram illustrating the configuration of an optical switch of embodiment 7 in the invention.

Four optical fibers 201, 202, 203 and 204 are disposed over a support 206 in an almost cross shape. In both cases where the end faces of the optical fibers are orthogonal to the central axis direction of the core, and where they are tilted to the plane orthogonal to the central axis direction of the core, the end faces of the optical fibers faced to each other are arranged in parallel with each other at a predetermined interval collinearly. In the optical paths at the crossing point where the four optical fibers are faced in a cross shape, a light reflector 205 is disposed. The light reflector 205 is mounted with a drive mechanism (not shown in the drawing), which allows the light reflector 205 to be taken in and out of the optical paths. For the four optical fibers 201, 202, 203 and 204, the optical fibers described in the embodiment 1 to the embodiment 3 in the invention are used. For the drive mechanism, various drive mechanisms can be used including an electromagnetic drive mechanism, an electrostatic drive mechanism, and a mechanical drive mechanism. The configuration in which guide grooves such as a V-groove are formed in the support 206 to arrange the four optical fibers in the guide grooves is desirable in that the positioning accuracy is enhanced.

When the light reflector 205 is inserted into the optical paths, the optical path of the light emitted from the tip end of the optical fiber 201 is bent by the light reflector 205 and the light enters the end face of the optical fiber 202. At the same time, the light emitted from the optical fiber 204 enters the end face of the optical fiber 203. When the light reflector 205 is removed from the optical paths, the light emitted from the tip end of the optical fiber 201 enters the end face of the optical fiber 203 and the light emitted from the optical fiber 204 enters the end face of the optical fiber 202.

According to the configuration of the optical switch in the embodiment, the end faces of the optical fibers are formed to be small, which allows the influence of interference due to the multi-reflection of light to be reduced between the end faces of the optical fibers and between the end faces of the optical fibers and the light reflector. The reproducibility of insertion loss and return loss and the temperature property are improved, and the optical switch of high performance can be realized.

When the traditional optical fibers are arranged in a cross shape as shown in FIG. 7, the claddings of the adjacent optical fibers physically interfere with each other. Therefore, the end faces of the optical fibers could not be brought close at a distance equal to or below the cladding diameter. However, according to the configuration of the optical switch in the embodiment, the outer diameter of the tip end of the optical fiber is small, and thus the optical fibers can be arranged closely. Accordingly, the insertion loss can be further reduced, and the optical switch of higher performance can be provided.

As described above, in the description of the embodiment 7 shown in FIG. 7, a 2×2 optical switch having four optical fibers disposed has been described. According to the configuration of removing the optical fiber 204 from the configuration of the embodiment, a 1×2 optical switch can be configured easily. Furthermore, according to the configuration of removing the optical fiber 204 and the optical fiber 202 at the same time, a 1×1 optical switch can be configured easily. The effect and advantage of these configurations are the same as the embodiment 7.

As described above, according to the configuration of the optical switch in the invention, in the optical switch in which the movable optical fiber is driven like a cantilever to open/close the optical paths, the end faces of the optical fibers are formed to be small. Thus, the influence of interference due to the multi-reflection of light can be reduced between the end faces of the optical fibers. The reproducibility of insertion loss and return loss and the temperature property can be improved. The movable optical fiber is moved at a short travel distance to allow the influence of crosstalk to be deceased.

In addition, in the optical switch formed of one movable optical fiber and two fixed optical fibers in which the movable optical fiber is driven like a cantilever to switch the optical paths, the end faces of the optical fibers are formed to be small. Therefore, the influence of interference due to the multi-reflection of light is reduced between the end faces of the optical fibers, and the reproducibility of insertion loss and return loss and the temperature property can be improved.

Furthermore, in the optical switch in shield is taken in and out between the end faces of the optical fibers to open/close the optical paths, the end faces of the optical fibers are formed to be small. Thus, the influence of interference due to the multi-reflection of light is reduced between the end faces of the optical fibers and between the end faces of the optical fibers and the light shield, and the reproducibility of insertion loss and return loss and the temperature property can be improved.

Moreover, in the optical switch in which the light reflector is taken in and out of the central space at a predetermined angle where three or four optical fibers are arranged in a cross shape or T-shape for switching the optical paths, the end faces of the optical fibers are formed to be small. Therefore, the influence of interference due to the multi-reflection of light is reduced between the end faces of the optical fibers and between the end faces of the optical fibers and the light reflector. The reproducibility of insertion loss and return loss and the temperature property can be improved. The interval between the end faces can be arranged closely to allow the insertion loss to be decreased.

Besides, the optical fiber in the invention is formed into an almost cone shape where the outer diameter is smaller as close to the end face near the end part, which allows the optical fiber having a small end face to be easily realized.

In addition, the vicinity of the end part of the optical fiber is configured of a tapered shape where the outer diameter is smaller as close to the end face and an almost cylindrical shape continued from the tapered shape. Thus, the optical fiber having a small end face can be easily realized, and the optical fiber easily mechanically driven can be implemented as well.

Furthermore, the vicinity of the end part of the optical fiber is formed into a wedge shape, which allows the optical fiber having a small end face to be easily realized.

Moreover, the end part of the optical fiber is formed to be flat and is formed in parallel or at a predetermined angle to the plane orthogonal to the core. Therefore, the end parts can be brought closer. Forming a predetermined angle allows return loss to be reduced.

Besides, an anti-reflection coating is formed over the end part of the optical fiber, which allows the multi-reflection between the end faces to be reduced effectively, and allows return loss to be further decreased.

What is claimed is:

1. An optical switch comprising:
a support;
a movable optical fiber having a first end face at an end part in which a base part is fixed to the support at a predetermined distance from the end part to be movable like a cantilever;
a fixed optical fiber having a second end face at an end part, the fixed optical fiber nearly collinearly arranged with the movable optical fiber in which the second end face is faced to the first end face in parallel with each other at a predetermined interval; and
a drive mechanism for driving the movable optical fiber to open/close an optical path,
wherein the movable optical fiber and the fixed optical fiber are optical fibers formed of a core for propagating light and a cladding disposed around the core, the cladding having a refractive index smaller than a refractive index of the core, and
an outer diameter of the end part continued to a transmission part for transmitting light is smaller than an outer diameter of the transmission part and greater than a diameter of the core.

2. An optical switch comprising:
a support;
a movable optical fiber having a first end face at an end part in which a base part is fixed to the support at a predetermined distance from an the end part to be movable like a cantilever;
a first fixed optical fiber having a second end face at an the end part, the first fixed optical fiber arranged nearly collinearly or nearly in parallel with the movable optical fiber in which the second end face is faced to the first end face in parallel with each other at a predetermined interval in a first position of the movable optical fiber;
a second fixed optical fiber having a third end face at an end part, the second fixed optical fiber arranged nearly in parallel with the first fixed optical fiber in which the third end face is faced to the first end face in parallel with each other at a predetermined interval in a second position of the movable optical fiber; and
a drive mechanism for driving the movable optical fiber to switch optical paths,
wherein the movable optical fiber and the first and second fixed optical fibers are optical fibers formed of a core for propagating light and a cladding disposed around the core, the cladding having a refractive index smaller than a refractive index of the core, and
an outer diameter of the end part continued to a transmission part for transmitting light is smaller than an outer diameter of the transmission part and greater than a diameter of the core.

3. An optical switch comprising:
a support;
two optical fibers faced to each other over the support so that end faces are in parallel with each other, the two optical fibers arranged nearly collinearly at a predetermined interval;
a light shield; and
a drive mechanism for driving the light shield, the optical switch for taking the light shield in and out between the end faces of the two optical fibers to open/close optical paths,
wherein the two optical fibers are optical fibers formed of a core for propagating light and a cladding disposed around the core, the cladding having a refractive index smaller than a refractive index of the core, and
an outer diameter of the end part continued to a transmission part for transmitting light is smaller than an outer diameter of the transmission part and greater than a diameter of the core.

4. An optical switch comprising:
a support;
four optical fibers faced to each other over the support so that end faces of the optical fibers are in parallel with each other, the optical fibers arranged in an almost cross shape at a predetermined interval;
a light reflector; and
a drive mechanism for taking the light reflector in and out of a central space where the four optical fibers are arranged at a predetermined angle to switch optical paths,
wherein the four optical fibers are optical fibers formed of a core for propagating light and a cladding disposed around the core, the cladding having a refractive index smaller than a refractive index of the core, and
an outer diameter of the end part continued to a transmission part for transmitting light is smaller than an outer diameter of the transmission part and greater than a diameter of the core.

5. An optical switch according to claim 4, wherein one optical fiber is removed among the four optical fibers to switch the optical paths among the three optical fibers arranged in an almost T-shape,
in which the three optical fibers are optical fibers formed of the core for propagating light and the cladding disposed around the core, the cladding having the refractive index smaller than the refractive index of the core, and
the outer diameter of the end part continued to the transmission part for transmitting light is smaller than the outer diameter of the transmission part and greater than the diameter of the core.

6. An optical switch according to claim 1, wherein the optical fiber has an almost cone shape where an outer diameter is smaller as close to the end face near the end part.

7. An optical switch according to claim 2, wherein the optical fiber has an almost cone shape where an outer diameter is smaller as close to the end face near the end part.

8. An optical switch according to claim 3, wherein the optical fiber has an almost cone shape where an outer diameter is smaller as close to the end face near the end part.

9. An optical switch according to claim 4, wherein the optical fiber has an almost cone shape where an outer diameter is smaller as close to the end face near the end part.

10. An optical switch according to claim 5, wherein the optical fiber has an almost cone shape where an outer diameter is smaller as close to the end face near the end part.

11. An optical switch according to claim 1, wherein the optical fiber has a tapered shape where an outer diameter is smaller as close to the end face near the end part, and has an almost cylindrical shape continued from the tapered shape.

12. An optical switch according to claim 2, wherein the optical fiber has a tapered shape where an outer diameter is smaller as close to the end face near the end part, and has an almost cylindrical shape continued from the tapered shape.

13. An optical switch according to claim 3, wherein the optical fiber has a tapered shape where an outer diameter is smaller as close to the end face near the end part, and has an almost cylindrical shape continued from the tapered shape.

14. An optical switch according to claim 4, wherein the optical fiber has a tapered shape where an outer diameter is smaller as close to the end face near the end part, and has an almost cylindrical shape continued from the tapered shape.

15. An optical switch according to claim 5, wherein the optical fiber has a tapered shape where an outer diameter is smaller as close to the end face near the end part, and has an almost cylindrical shape continued from the tapered shape.

16. An optical switch according to claim 1, wherein the optical fiber has a wedge shape near the end part.

17. An optical switch according to claim 2, wherein the optical fiber has a wedge shape near the end part.

18. An optical switch according to claim 3, wherein the optical fiber has a wedge shape near the end part.

19. An optical switch according to claim 4, wherein the optical fiber has a wedge shape near the end part.

20. An optical switch according to claim 5, wherein the optical fiber has a wedge shape near the end part.
